(19) United States
(12) Patent Application Publication
(10) Pub. No.: US 2023/0128381 A1
(43) Pub. Date: Apr. 27, 2023

(54) PARTICLE GROUP, POWDER COMPOSITION, SOLID COMPOSITION, LIQUID COMPOSITION, AND COMPACT

(71) Applicant: Sumitomo Chemical Company, Limited, Chuo-ku, Tokyo (JP)

(72) Inventors: Shinichi SASAKI, Tsukuba-shi, Ibaraki (JP); Atsunori DOI, Tsukuba-shi (JP); Takashi ARIMURA, Tsukuba-shi, Ibaraki (JP); Satoshi SHIMANO, Tsukuba-shi, Ibaraki (JP)

(21) Appl. No.: 17/914,002

(22) PCT Filed: Apr. 7, 2021
(86) PCT No.: PCT/JP2021/014692

§ 371 Date: Sep. 23, 2022

(30) Foreign Application Priority Data
Apr. 22, 2020 (JP) 2020-076150

(51) Int. Cl. C04B 35/46; C04B 35/628; C04B 35/626; C04B 35/64

(52) U.S. Cl. CPC C04B 35/46; C04B 35/64; C04B 35/6268; C04B 35/62807; C04B 35/62813; C04B 35/62886; C04B 2235/404; C04B 2235/3217; C04B 2235/3232; C04B 2235/3418; C04B 2235/5436; C04B 2235/5445

(57) ABSTRACT

A coated particle having excellent thermal expansion control and electrical insulation properties includes a core of a first inorganic compound containing a metal or semimetal element P; and a shell of a second inorganic compound containing a metal or semimetal element Q. The first inorganic compound satisfies 1, and the coated particles satisfy 2 and 3. 1: |dA(T)/dT| is ≥10 ppm/°C at T1 of -200° C. to 1,200° C. A is (an a-axis lattice constant of a crystal in the first inorganic compound)/(a c-axis lattice constant of a crystal in the first inorganic compound). 2: in XPS of a surface of each of the coated particles, a ratio of a number of atoms of Q contained in the shell to a number of atoms of P contained in the core t is 45 to 300. 3: an average particle diameter of each coated particle is 0.1 to 100 µm.

### TECHNICAL FIELD

The present invention relates to a particle group, a powder composition, a solid composition, a liquid composition, and a compact.

### BACKGROUND ART

For example, Patent Document 1 discloses a technique in which the linear thermal expansion coefficient of a composition containing a resin is reduced and controlled to a desired level by using particles of tungsten zirconium phosphate which is a material exhibiting a negative linear thermal expansion coefficient as an additive. In addition, Patent Document 2 discloses a manganese nitride as a material exhibiting large negative thermal expansion characteristics.

### Prior Art Documents

### Patent documents

Patent Document 1: JP-A-2018-2577
Patent Document 2: CN-A-101532104

### SUMMARY OF THE INVENTION

### Problems to Be Solved by the Invention

However, in the material disclosed in Patent Document 1, the linear thermal expansion coefficient of the composition is not necessarily sufficiently lowered. In addition, the material disclosed in Patent Document 2 is a good electrical conductor, and the composition may also be a good conductor. For example, members for electronic devices, such as a semiconductor sealing member and a circuit board are required to have electrical insulation properties, and thus are difficult to apply.

The present invention has been made in view of the above circumstances, and an object thereof is to provide a particle group having excellent thermal expansion control characteristics and excellent electrical insulation properties.

### Means for Solving the Problems

As a result of various studies, the present inventors have reached the present invention. That is, the present invention provides the following invention.

A particle group according to the present invention includes a plurality of coated particles, each of the coated particles including: a core part made of a first inorganic compound containing a metal or semimetal element P; and a shell part made of a second inorganic compound containing a metal or semimetal element Q, the shell part covering at least a part of a surface of the core part. The metal or semimetal element P and the metal or semimetal element Q are different elements from each other, or are the same elements but have different electronic states from each other. The volume resistivity of the second inorganic compound is higher than the volume resistivity of the first inorganic compound. The first inorganic compound satisfies requirement 1, and each of the coated particles satisfies requirements 2 and 3.

Requirement 1: |dA(T)/dT| is 10 ppm/°C or more at at least one temperature T1 in a range of -200° C. to 1,200° C.

A is (an a-axis (shorter axis) lattice constant of a crystal in the first inorganic compound)/(a c-axis (longer axis) lattice constant of a crystal in the first inorganic compound), and each of the lattice constants is obtained from X-ray diffractometry of the first inorganic compound.

Requirement 2: in X-ray photoelectron spectroscopy (XPS) of a surface of each of the coated particles, a ratio Q_{XPS}, _{SHELL}/P_{XPS}, _{CORE} of a number of atoms Q_{XPS}, _{SHELL} of the metal or semimetal element Q contained in the shell part to a number of atoms P_{XPS}, _{CORE} of the metal or semimetal element P contained in the core part is 45 or more and 300 or less.

Requirement 3: an average particle diameter of each of the coated particles is 0.1 µm or more and 100 µm or less.

Here, each of the coated particles can further satisfy requirement 4.

Requirement 4: in all of the coated particles included in the particle group, a ratio Q_{ALL}/P_{ALL} of a total Q_{ALL} of a number of atoms of the metal or semimetal element Q to a total P_{ALL} of a number of atoms of the metal or semimetal element P is 0.20 or more and 0.50 or less.

The metal or semimetal element P can be a metal element having a d electron.

The metal or semimetal element P can be titanium.

The first inorganic compound can be TiOₓ where x is 1.30 to 1.66.

The metal or semimetal element Q can be Al, Si, or Zr.

The second inorganic compound can be at least one compound selected from the group consisting of an oxide, a hydroxide oxide, and a hydroxide.

The second inorganic compound can be at least one compound selected from the group consisting of aluminum oxide, aluminum hydroxide oxide, and aluminum hydroxide.

A powder composition according to the present invention includes the particle group.

A solid composition according to the present invention contains the particle group or the powder composition.

A liquid composition according to the present invention contains the particle group or the powder composition.

A compact according to the present invention is a compact of the particle group or the powder composition.

### Effect of the Invention

According to the present invention, it is possible to provide a particle group or the like of coated particles having excellent thermal expansion control characteristics and excellent electrical insulation properties.

### BRIEF DESCRIPTION OF THE DRAWING

FIG. 1 is a schematic cross-sectional view of a coated particle of the present embodiment.

### MODE FOR CARRYING OUT THE INVENTION

### Coated Particle

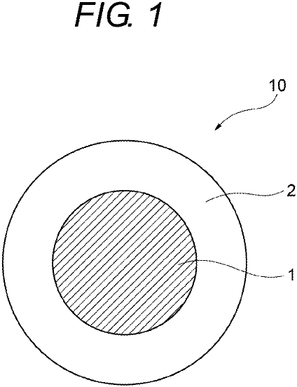

The particle group according to the present embodiment includes a plurality of coated particles. As shown in FIG. 1, a coated particle 10 includes: a core part 1 made of a first inorganic compound containing a metal or semimetal element P; and a shell part 2 covering at least a part of the surface of the core part 1 and made of a second inorganic compound containing a metal or semimetal element Q.

The metal or semimetal element P and the metal or semimetal element Q are different elements from each other, or are the same elements but have different electronic states from each other. The volume resistivity of the second inorganic compound is higher than the volume resistivity of the first inorganic compound. The first inorganic compound satisfies the requirement 1, and the coated particle satisfies the requirements 2 and 3.

Requirement 1: |dA(T)/dT| is 10 ppm/°C or more at at least one temperature T1 in a range of -200° C. to 1,200° C.

A is (an a-axis (shorter axis) lattice constant of a crystal in the first inorganic compound)/(a c-axis (longer axis) lattice constant of a crystal in the first inorganic compound), and each of the lattice constants is obtained from X-ray diffractometry of the first inorganic compound.

Requirement 2: in XPS of a surface of each of the coated particles, a ratio Q_{XPS}, _{SHELL}/P_{XPS}, _{CORE} of a number of atoms Q_{XPS}, _{SHELL} of the metal or semimetal element Q contained in the shell part to a number of atoms P_{XPS}, _{CORE} of the metal or semimetal element P contained in the core part is 45 or more and 300 or less.

Requirement 3: an average particle diameter of each of the coated particles is 0.1 µm or more and 100 µm or less.

Details of the coated particle will be described below.

The coated particle 10 according to the present embodiment includes: the core part 1 made of a first inorganic compound; and the shell part 2 covering at least a part of the surface of the core part 1 and made of a second inorganic compound. The shape of the core part 1 is not particularly limited, and may be, for example, a spherical, ellipsoid, cylindrical, polyhedral, or amorphous single particle, or may be an aggregate of a plurality of particles made of the first inorganic compound having an optional shape. The shape of the shell part 2 of the second inorganic compound is also not particularly limited, and may be a dense film made of the second inorganic compound, or may be a mass (aggregation layer) of groups of particles made of the second inorganic compound. The coated particle group according to the embodiment of the present application may include coated particles in which the shell part 2 covers at least a part of the surface of the core part 1, and may also include coated particles in which the shell part 2 completely covers the surface of the core part 1 as shown in FIG. 1.

### First Inorganic Compound and Second Inorganic Compound

The first inorganic compound contains a metal or semimetal element P, and the second inorganic compound contains a metal or semimetal element Q.

Each of the first inorganic compound and the second inorganic compound may contain only one type of “metal or semimetal element”, but may contain a plurality of types of “metals or semimetal elements”.

When the first inorganic compound contains only one type of metal or semimetal element, the metal or semimetal element is referred to as a “metal or semimetal element P”. When the first inorganic compound contains a plurality of types of metals or semimetal elements, an element occupying the maximum ratio of the number of atoms among the metals or semimetal elements is referred to as a “metal or semimetal element P”. When the first inorganic compound contains a plurality of metals or semimetal elements and there are a plurality of elements occupying the maximum ratio of the number of atoms among the metals or semimetal elements, an optional element among the elements occupying the maximum ratio of the number of atoms can be set as a “metal or semimetal element P”.

When the second inorganic compound contains only one type of metal or semimetal element, the metal or semimetal element is referred to as “metal or semimetal element Q”. When the second inorganic compound contains a plurality of types of metals or semimetal elements, an element occupying the maximum ratio of the number of atoms among the metals or semimetal elements is referred to as a “metal or semimetal element Q”. When the second inorganic compound contains a plurality of types of metals or semimetal elements and there are a plurality of elements occupying the maximum ratio of the number of atoms among the metals or semimetal elements, an optional element among the elements occupying the maximum ratio of the number of atoms can be set as a “metal or semimetal element Q”.

The “metal or semimetal element P” and the “metal or semimetal element Q” can be different elements from each other. In addition, the “metal or semimetal element P” and the “metal or semimetal element Q” may be the same element, but in that case, it is necessary that the electronic states of the elements, for example, the valences of the elements are different from each other.

The first inorganic compound may contain the “metal or semimetal element Q” of the second inorganic compound as long as the ratio of the number of atoms of the metal or semimetal element Q in the first inorganic compound is not the maximum.

The second inorganic compound may contain the “metal or semimetal element P” of the first inorganic compound as long as the ratio of the number of atoms of the metal or semimetal element P in the second inorganic compound is not the maximum.

Each of the first inorganic compound and the second inorganic compound is a compound in which one or more types of metals or semimetal elements are combined with one or more types of elements selected from the group consisting of hydrogen, carbon, nitrogen, oxygen, phosphorus, sulfur, selenium, fluorine, chlorine, bromine, and iodine, or a mixture consisting only of two or more types of the above compounds. Examples thereof include hydrides, carbides, nitrides, oxides, hydroxide oxides, hydroxides, phosphides, sulfides, selenides, fluorides, chlorides, bromides, iodides, carbonates, acetates, nitrates, phosphates, selenates, hypofluorites, hypochlorites, chlorites, chlorates, perchlorates, hypobromites, bromites, bromates, perbromates, hypoiodites, iodites, iodates, and periodates of metals or semimetal elements. In addition, oxo acids, hydroxo acids, and aqua acids of metal elements or semimetal elements; and salts thereof may be used.

The metal element in the present specification is Li, Na, Mg, Al, K, Ca, Sc, Ti, V, Cr, Mn, Fe, Co, Ni, Cu, Zn, Ga, Rb, Sr, Y, Zr, Nb, Mo, Tc, Ag, Cd, In, Sn, Cs, Ba, Hf, Ta, W, Re, Au, Hg, Tl, Pb, Bi, Ce, Pr, Nd, Pm, Sm, Eu, Gd, Tb, Dy, Ho, Er, Tm, Yb, and Lu. The semimetal element in the present specification is B, Si, Ge, As, Sb, Te, Po, and At.

The metal or semimetal element P is preferably a metal element having d electrons among the metals or semimetal elements in the above group. The first inorganic compound is preferably a metal oxide containing a metal element having d electrons. The metal element having d electrons is not particularly limited, and examples thereof include a metal element of the fourth period selected from the group consisting of Sc, Ti, V, Cr, Mn, Fe, Co, Ni, and Cu; a metal element of the fifth period selected from the group consisting of Y, Zr, Nb, and Mo; and a metal element of the sixth period selected from the group consisting of Hf, Ta, and W.

Among the above metal elements, the first inorganic compound is preferably a metal oxide containing a metal element of the fourth period or the fifth period as the metal element P, and more preferably a metal oxide containing a metal element of the fourth period. The metal element of the fourth period is a metal element having only 3d electrons among d electrons. In particular, from the viewpoint of the occupied state of 3d electrons, the first inorganic compound is preferably a metal oxide containing, as the metal element P, one metal element selected from the group consisting of Ti, V, Cr, Mn, and Co among the metal elements of the fourth period. From the viewpoint of resource, the first inorganic compound is preferably a metal oxide containing titanium as the metal element P among these metal elements.

The metal oxide containing titanium is preferably represented by a composition formula TiOₓ (x = 1.30 to 1.66), and more preferably represented by a composition formula TiOₓ (x = 1.40 to 1.60). In TiOₓ, some of Ti atoms may be substituted with another element.

The metal oxide containing titanium may be an oxide containing titanium and metal elements other than titanium, such as LaTiO₃, in addition to the TiOₓ.

The crystal structure of the first inorganic compound preferably has a perovskite structure or a corundum structure, and more preferably has a corundum structure.

The crystal system is not particularly limited, but is preferably a rhombohedral system. The space group is preferably attributed to R-3c.

When the first inorganic compound is a metal oxide containing a metal element having d electrons, as the metal element P, |dA(T)/dT| at -100° C. to 1,000° C. is preferably 10 ppm/°C or more at at least one temperature.

When the first inorganic compound is a metal oxide containing a metal element having only 3d electrons among d electrons, as the metal element P, |dA(T)/dT| at -100° C. to 800° C. is preferably 10 ppm/°C or more at at least one temperature.

When the first inorganic compound is TiOₓ (x = 1.30 to 1.66), |dA(T)/dT| at 0° C. to 500° C. is preferably 10 ppm/°C or more at at least one temperature.

Preferably, the second inorganic compound includes at least one or more compounds selected from the group consisting of an oxide, a hydroxide oxide, and a hydroxide. More preferably, the second inorganic compound is composed of only at least one or more compounds selected from the group consisting of an oxide, a hydroxide oxide, and a hydroxide.

In the second inorganic compound, the total amount of the at least one or more compounds selected from the group consisting of an oxide, a hydroxide oxide, and a hydroxide preferably has a large weight ratio with respect to all compounds other than the oxide, the hydroxide oxide, and the hydroxide contained in the second inorganic compound. When the second inorganic compound is the compound described above, the value of the ratio M described later is easily adjusted, and particles having excellent thermal expansion control characteristics and excellent electrical insulation properties are easily obtained.

From the viewpoint of thermal stability, the second inorganic compound preferably contains, as the metal or semimetal element Q, one element selected from the group consisting of Al, Si, Sc, Ti, V, Cr, Mn, Fe, Co, Ni, Cu, Zn, Zr, Nb, and Mo among the metal elements or semimetal elements in the above group. Among the above elements, the second inorganic compound more preferably contains one element selected from the group consisting of Al, Si, and Zr, as the metal or semimetal element Q, from the viewpoint of thermal stability of an oxide, a hydroxide oxide, and a hydroxide.

Examples of such a second inorganic compound include aluminum oxide, aluminum hydroxide oxide, aluminum hydroxide, silicon oxide, and zirconium oxide. From the viewpoint of the thermal stability of the coated particle according to the present embodiment, the second inorganic compound is preferably at least one compound selected from the group consisting of aluminum oxide, aluminum hydroxide oxide, and aluminum hydroxide.

The second inorganic compound may be crystalline or amorphous. When the second inorganic compound is crystalline, the crystal structure of the second inorganic compound is not particularly limited.

From the viewpoint of imparting electrical insulation properties to the coated particle, the volume resistivity of the second inorganic compound is higher than the volume resistivity of the first inorganic compound. The volume resistivity of the second inorganic compound is preferably 10³ Ωcm or more, more preferably 10⁵ Ωcm or more, and still more preferably 10⁷ Ωcm or more.

### Requirement 1

Next, the requirement 1 will be described in detail.

The lattice constant in the definition of A is specified by powder X-ray diffractometry. As an analysis method, there are a Rietveld method and an analysis by fitting by a least-squares method.

In the present specification, in the crystal structure of the first inorganic compound, which is specified by powder X-ray diffractometry, an axis corresponding to the smallest lattice constant is defined as an a-axis, and an axis corresponding to the largest lattice constant is defined as a c-axis. The length of the a-axis and the length of the c-axis of the crystal lattice are defined as an a-axis length and a c-axis length, respectively. In the present specification, the a-axis lattice constant of the titanium compound crystal grain is the a-axis length, and the c-axis lattice constant of the titanium compound crystal grain is the c-axis length.

A(T) is a parameter indicating the magnitude of anisotropy of the length of the crystal axis, and is the function of a temperature T (unit: °C). A larger value of A(T) indicates that the a-axis length is larger relative to the c-axis length, and a smaller value of A indicates that the a-axis length is smaller relative to the c-axis length.

Here, |dA(T)/dT| represents the absolute value of dA(T)/dT, and dA(T)/dT represents the differential of A(T) by T (temperature).

Here, in the present specification, |dA(T)/dT| is defined by the following Equation (D).

$$\left|\text{dA} \left(\text{T}\right) / \text{dT}\right| = \left|\text{A} \left(\text{T + 50}\right) - \text{A} \left(\text{T}\right)\right| / 50$$

As described above, the first inorganic compound according to the present embodiment needs to satisfy |dA(T)/dT| of 10 ppm/°C or more at at least one temperature T1 in a range of -200° C. to 1,200° C. Note that |dA(T)/dT| is defined within a range where the first inorganic compound exists in a solid state. Therefore, the maximum temperature of T in Equation (D) is up to a temperature 50° C. lower than the melting point of the particle. That is, when the limitation “at least one temperature T1 in a range of -200° C. to 1,200° C.” is added, the temperature range of T in Equation (D) is -200 to 1,150° C.

|dA(T)/dT| is preferably 20 ppm/°C or more, and more preferably 30 ppm/°C or more at at least one temperature T1 in a range of -200° C. to 1,200° C. The upper limit of |dA(T)/dT| is preferably 1,000 ppm/°C or less, and more preferably 500 ppm/°C or less.

The fact that the value of |dA(T)/dT| is 10 ppm/°C or more at the at least one temperature T1 means that the change in anisotropy of the crystal structure associated with the temperature change is large.

At the at least one temperature T1, dA(T)/dT may be positive or negative, but is preferably negative.

Depending on the type of crystal of the first inorganic compound, there is a compound whose crystal structure changes due to structural phase transition in a certain temperature range. In the present specification, in a crystal structure at a certain temperature, an axis having the largest crystal lattice constant is defined as a c-axis, and an axis having the smallest crystal lattice constant is defined as an a-axis. In any crystal system of the triclinic system, monoclinic system, orthorhombic system, tetragonal system, hexagonal system, and rhombohedral system, the a-axis and the c-axis are defined as described above.

When the first inorganic compound satisfies the requirement 1, it is easy to lower the linear thermal expansion coefficient in a solid composition or molded article containing the coated particles.

### Requirement 2

Next, the requirement 2 will be described.

In XPS of the surface of the coated particle 10, the ratio M (Q_{XPS}, _{SHELL}/P_{XPS}, _{CORE}) of the number of atoms Q_{XPS}, _{SHELL} of the “metal or semimetal element Q” contained in the shell part 2 to the number of atoms P_{XPS}, _{CORE} of the “metal or semimetal element P” contained in the core part 1 is 45 or more and 300 or less.

XPS is a quantitative and qualitative analysis method capable of analyzing the number of constituent elements in a surface region of a sample and the electronic state of the sample by irradiating the sample with X-rays having specific energy and measuring the number and energy of photoelectrons generated by a photoelectric effect. As the X-ray source, for example, an Al-Kα ray or a Mg-Kα ray is used. In the present application, a region where photoelectrons generated in a sample can escape out from the sample without losing energy when an Al-Kα ray is used as the X-ray source is defined as the surface region. Although there is a slight difference depending on the energy of the generated photoelectrons, the depth of the surface region is about 5 nm.

That is, the ratio M represents the ratio of the number of atoms of the “metal or semimetal element Q″ contained in the shell part 2 to the number of atoms of the” metal or semimetal element P″ contained in the core part 1 at a thickness of about 5 nm of the surface region of the coated particle. The ratio M is an index representing how much the surface of the core part 1 made of the first inorganic compound is covered with the shell part 2 made of the second inorganic compound.

A large ratio M indicates that most of the surface of the core part 1 made of the first inorganic compound is covered with the shell part 2 made of the second inorganic compound. From the viewpoint of imparting electrical insulation properties to the coated particle 10, the ratio M is preferably 50 or more, more preferably 60 or more, still more preferably 70 or more, and particularly preferably 80 or more. The ratio M is preferably 280 or less, more preferably 270 or less, still more preferably 265 or less, and particularly preferably 261 or less, from the viewpoint of exerting a high effect of suppressing thermal expansion by the core part 1 so that the surface of the core part 1 made of the first inorganic compound is not excessively covered with the shell part 2 made of the second inorganic compound.

The ratio M can be determined as follows according to the existence situation of the metal or semimetal element P in the core part 1 and the metal or semimetal element Q in the shell part 2.

### Existence Situation 1

In a case where the “metal or semimetal element P” contained in the core part 1 made of the first inorganic compound is not contained in the shell part 2 made of the second inorganic compound, and the “metal or semimetal element Q” contained in the shell part 2 made of the second inorganic compound is not contained in the core part 1 made of the first inorganic compound, the number of atoms of the “metal or semimetal element P” obtained by XPS is derived only from the core part 1, and the number of atoms of the “metal or semimetal element Q” obtained by XPS is derived only from the shell part 2. Therefore, the ratio M can be directly calculated as the ratio of the number of atoms of the element Q to the number of atoms of the element P obtained by XPS.

Specifically, the area values of peaks attributed to the element P and the element Q present in the spectrum obtained by XPS are obtained. Then, the area value of each peak is multiplied by a relative sensitivity factor depending on the apparatus, to obtain the number of atoms P_{XPS}, _{CORE} of the element P and the number of atoms Q_{XPS}, _{SHELL} of the element Q. The ratio M of the number of atoms can be calculated as Q_{XPS}, _{SHELL}/P_{XPS,} _{CORE}.

As described above, in the present embodiment, even if the “metal or semimetal element P” and the “metal or semimetal element Q” are the same element, when the electronic states of the elements are different from each other, such as a case where the valences of the elements are different from each other, the element P and the element Q can be distinguished in XPS, and the ratio M can be calculated.

For example, when the first inorganic compound is Ti₂O₃, the metal element P is Ti³⁺, and when the second inorganic compound is TiO₂, the metal element Q is Ti⁴⁺, but this case is also measurable.

### Existence Situation 2

In a case where the “metal or semimetal element P” contained in the core part 1 made of the first inorganic compound is contained in the shell part 2 made of the second inorganic compound and/or the “metal or semimetal element Q” contained in the shell part 2 made of the second inorganic compound is contained in the core part 1 made of the first inorganic compound, the number of atoms of the element P and the element Q obtained by XPS is derived from both the core part 1 and the shell part 2. In this case, the ratio M can be calculated as follows.

The number of atoms P_{XPS}, _{TOTAL} of the element P obtained by XPS can be expressed by Equation (1) with separated contributions of the core part 1 and the shell part 2. Here, the contribution of the core part 1 in the number of atoms is represented by a subscript CORE, the contribution of the shell part 2 is represented by a subscript SHELL, and the contributions of both the core part 1 and the shell part 2 are represented by a subscript TOTAL.

$${\text{P}}_{\text{XPS,} \text{TOTAL}} = {\text{P}}_{\text{XPS, CORE}} + {\text{P}}_{\text{XPS,} \text{SHELL}}$$

The number of atoms Q_{XPS}, _{TOTAL} of the element Q obtained by XPS can be similarly represented as Equation (2) .

$${\text{Q}}_{\text{XPS,} \text{TOTAL}} = {\text{Q}}_{\text{XPS, CORE}} + {\text{Q}}_{\text{XPS,} \text{SHELL}}$$

In addition, when the ratio of the number of atoms of the element Q to the element P in the core part 1 is R_{CORE} and the ratio of the number of atoms of the element P to the element Q in the shell part 2 is R_{SHELL}, the following equation is established for the number of atoms in the core part 1 and the number of atoms in the shell part 2.

$${\text{Q}}_{\text{XPS, CORE}} / {\text{P}}_{\text{XPS, CORE}} = {\text{R}}_{\text{CORE}}$$

$${\text{P}}_{\text{XPS, SHELL}} / {\text{Q}}_{\text{XPS, SHELL}} = {\text{R}}_{\text{SHELL}}$$

Here, R_{CORE} and R_{SHELL} can be measured by the following method separately from the surface measurement by XPS. Therefore, in Equations (1) to (4), P_{XPS}, _{TOTAL}, Q_{XPS}, _{TOTAL}, R_{CORE}, and R_{SHELL} are known values, and unknown P_{XPS}, _{CORE}, P_{XPS}, _{SHELL}, Q_{XPS}, _{CORE}, and Q_{XPS}, _{SHELL} can be obtained by solving these simultaneous equations.

In addition, in a case where the “metal or semimetal element P” contained in the core part 1 made of the first inorganic compound is contained in the shell part 2 made of the second inorganic compound, but the “metal or semimetal element Q” contained in the shell part 2 made of the second inorganic compound is not contained in the core part 1 made of the first inorganic compound (case 1), and in a case where the “metal or semimetal element P” contained in the core part 1 made of the first inorganic compound is not contained in the shell part 2 made of the second inorganic compound, but the “metal or semimetal element Q” contained in the shell part 2 made of the second inorganic compound is contained in the core part 1 made of the first inorganic compound (case 2), the above equations are simplified as follows.

First, the definition of M in the requirement 2 is the following Equation (5), and Equation (6) is derived using Equations (1) and (2).

$$\text{M =} {\text{Q}}_{\text{XPS, SHELL}} / {\text{P}}_{\text{XPS, CORE}}$$

$$= \left({\text{Q}}_{\text{XPS,} \text{TOTAL}} - {\text{Q}}_{\text{XPS, CORE}}\right) / \left({\text{P}}_{\text{XPS,} \text{TOTAL}} - {\text{P}}_{\text{XPS,} \text{SHELL}}\right)$$

Here, the above case 2 is considered, for example.

In this case, since the element P contained in the core part 1 is not contained in the shell part 2, P_{XPS}, _{SHELL} is 0, and Equation (6) becomes the following Equation (7), and Equation (1) becomes the following Equation (8).

$$\text{M} = \left({\text{Q}}_{\text{XPS,} \text{TOTAL}} - {\text{Q}}_{\text{XPS, CORE}}\right) / {\text{P}}_{\text{XPS,} \text{TOTAL}}$$

$${\text{P}}_{\text{XPS,} \text{TOTAL}} = {\text{P}}_{\text{XPS,} \text{CORE}}$$

Therefore, the following Equation (9) is obtained from Equation (3).

$${\text{Q}}_{\text{XPS,} \text{CORE}} = {\text{R}}_{\text{CORE}} ⋅ {\text{P}}_{\text{XPS,} \text{CORE}} = {\text{R}}_{\text{CORE}} ⋅ {\text{P}}_{\text{XPS,} \text{TOTAL}}$$

Therefore, the following Equation (10) is obtained by substituting Equation (9) into Equation (7).

$$\text{M} = \left({\text{Q}}_{\text{XPS,} \text{TOTAL}} - {\text{R}}_{\text{CORE}} ⋅ {\text{P}}_{\text{XPS,} \text{TOTAL}}\right) / {\text{P}}_{\text{XPS,} \text{TOTAL}}$$

For example, in a case where the first inorganic compound of the core part 1 is Ti_{1.8}Al_{0.2}O₃ and the second inorganic compound of the shell part 2 is Al₂O₃, the “metal or semimetal element P” is Ti, the “metal or semimetal element Q” in the second inorganic compound is Al, and the element Q of the shell part 2 is also included in the core part 1, whereas the element P of the core part 1 is not included in the shell part 2. R_{CORE} is 0.2/1.8 = 0.111.

The above calculation can be similarly performed even in the case 1 in which the element Q included in the shell part 2 is not included in the core part 1 with Q_{XPS}, _{CORE} being 0.

The atomic ratio R_{CORE} of the element Q to the element P in the core part 1 and the atomic ratio R_{SHELL} of the element P to the element Q in the shell part 2 can be determined by observing a cross section of a coated particle with a scanning electron microscope (SEM), a transmission electron microscope (TEM), or the like, and performing energy dispersive X-ray spectroscopy (EDX) on each of the core part and the shell part. From the viewpoint of enhancing spatial resolution, a method of observing with a TEM is preferable. In order to calculate the ratio of the number of atoms more accurately, a method of preparing a cross section of a coated particle with a focused ion beam (FIB) apparatus or an ion milling apparatus, and observing the cross section of the coated particle obtained by the processing with an electron microscope is preferable.

The fact that the coated particle 10 satisfies the requirement 2 indicates that most of the surface of the core part 1 made of the first inorganic compound is covered with the shell part 2 made of the second inorganic compound. Such covering with the shell part 2 contributes to imparting electrical insulation properties to the coated particle 10 while exerting a high effect of suppressing thermal expansion by the core part 1.

### Requirement 3

Next, the requirement 3 will be described. The average particle diameter of the coated particles in the particle group is 0.1 µm or more and 100 µm or less. The average particle diameter is obtained based on D50 of a volume-based cumulative particle diameter distribution curve of coated particles measured by a laser diffraction scattering method. The measurement method is shown below.

As the pretreatment, 99 parts by weight of water is added to 1 part by weight of powder of particle group of coated particles for dilution, and ultrasonic treatment is performed with an ultrasonic cleaner. The ultrasonic treatment time is set to 10 minutes. As the ultrasonic cleaner, NS200-6U, manufactured by NISSEI Corporation can be used. The frequency of the ultrasonic wave is about 28 kHz.

For the measurement, the volume-based particle diameter distribution is measured by a laser diffraction scattering method. For example, a laser diffraction particle diameter distribution measuring apparatus Mastersizer 2000, manufactured by Malvern Instruments Ltd. can be used. For example, when the core part of the coated particle is Ti₂O₃, the refractive index of Ti₂O₃ can be measured as 2.40.

In the present specification, a particle diameter, at which the cumulative frequency in the volume-based cumulative particle diameter distribution curve, as calculated from the smallest particle diameter side is 50%, is defined as D50. As described above, in the particle group according to the present embodiment, D50 needs to be 0.1 µm or more and 100 µm or less. D50 is preferably 0.5 µm or more, more preferably 1 µm or more, and still more preferably 2 µm or more. When D50 is in such a range, aggregated particles are hardly formed, and the effect of suppressing thermal expansion when particles are kneaded with a matrix material such as a resin is easily improved. D50 is preferably 50 µm or less, more preferably 30 µm or less, and still more preferably 20 µm or less. When D50 is in such a range, the particle interface is increased, and the electrical insulation properties when particles are kneaded with a matrix material such as a resin are easily improved.

### Requirement 4

Next, the requirement 4 which is an optional requirement will be described.

In the particle group of the present embodiment, the ratio N (Q_{ALL}/P_{ALL}) of the total Q_{ALL} of the number of atoms of the metal or semimetal element Q to the total P_{ALL} of the number of atoms of the metal or semimetal element P in all the coated particles included in the particle group is 0.20 or more and 0.50 or less.

From the viewpoint of imparting electrical insulation properties to the coated particle, the ratio N is preferably 0.20 or more, more preferably 0.23 or more, and still more preferably 0.25 or more. From the viewpoint that the coated particle exhibits a high effect of suppressing thermal expansion, the ratio N is preferably 0.50 or less, more preferably 0.47 or less, and still more preferably 0.45 or less.

When the coated particle satisfies the requirement 4, it is easy to achieve a balance between a high effect of suppressing thermal expansion and an effect of imparting electrical insulation properties.

When the coated particle satisfies the requirements 2 and 4 and the value of the ratio M is larger than the value of the ratio N, in the coated particle according to the present invention, the core part made of the first inorganic compound containing the metal or semimetal element P is sufficiently covered with the shell part made of the second inorganic compound containing the metal or semimetal element Q.

The ratio N can be calculated by, for example, making the entire coated particles into a solution and then subjecting the solution to inductively coupled plasma atomic emission spectroscopy (ICP-AES). Examples of the method for making particles into a solution include acid dissolution and alkali fusion.

First, a crucible made of an appropriate material is selected depending on the composition of the coated particle, such as a nickel crucible or a platinum crucible. A certain amount of coated particles is weighed and placed in the crucible, and an acid such as hydrochloric acid, nitric acid, sulfuric acid, or hydrofluoric acid is added thereto. Then, the mixture is heated to perform acid dissolution. From the viewpoint of further promoting dissolution, acid dissolution may be performed by placing coated particles in a container for pressure acid decomposition and dissolving the particles by heating while pressurizing the particles, or heating particles while applying a microwave to the particles, to thereby decompose the particles.

Depending on the composition of the coated particle, alkali fusion may be performed by weighing a certain amount of coated particles, placing the particles in a crucible, then adding a flux such as sodium hydroxide or sodium carbonate, or a mixed flux of sodium carbonate and boric acid or the like thereto, and heating the mixture at a high temperature. In the case of alkali fusion, the coated particles can be made into a solution by subsequently adding an acid such as hydrochloric acid, nitric acid, sulfuric acid, or hydrofluoric acid to be acidic.

The sample solution is appropriately diluted to a concentration region that can be measured by an ICP-AES apparatus, the sample is introduced into the ICP-AES apparatus, and then quantitative analysis of elements contained in the sample is performed. From the results of ICP-AES, the ratio N of the total number of atoms of the metal or semimetal element Q to the total number of atoms of the metal or semimetal element P in the entire coated particle is calculated.

### Method for Producing Coated Particles

The method for producing a particle group of coated particles according to the present embodiment is not particularly limited. The production method can include, for example, the following steps:
Step (1): Step of mixing a raw material of a second inorganic compound with a solvent to prepare a solution;
Step (2): Step of mixing a particle group of a first inorganic compound with the solution;
Step (3): Step of precipitating a precursor of the second inorganic compound in the solution;
Step (4): Step of separating a mixture containing the particle group of the first inorganic compound and the precursor of the second inorganic compound from the solvent;
Step (5): Step of converting the precursor of the second inorganic compound into the second inorganic compound; and
Step (6): Step of crushing the group of particles containing the first inorganic compound and the second inorganic compound as necessary to obtain coated particles.

### Step

The raw material of the second inorganic compound refers to a material that contains a metal or semimetal element Q and can be converted into a precursor of the second inorganic compound in the step (3). The raw material of the second inorganic compound is not limited to the inorganic compound, and may be, for example, an organic substance such as an organometallic complex. The type of solvent is not particularly limited, and can be, for example, water or an organic solvent. In addition, a solute of an inorganic compound or an organic substance may be dissolved in the solvent. After the raw material of the second inorganic compound is mixed with the solvent to prepare a solution, another substance may be further mixed with the solution.

### Step

The method for mixing the group of particles of the first inorganic compound with the solution is not particularly limited. For example, the particles of the first inorganic compound can be mixed by adding the particles of the first inorganic compound to the solution in a state of being stirred. The particle group of the first inorganic compound may be added alone, or may be added simultaneously with another solvent or solute. The raw material of the second inorganic compound may be changed to another substance or precipitated as a solid, through mixing with the particle group of the first inorganic compound.

### Step

The precursor of the second inorganic compound refers to a substance that can be converted into the second inorganic compound by a step described later. The precursor of the second inorganic compound may be the same substance as or a different substance from the raw material of the second inorganic compound. Examples of the method for precipitating the precursor of the second inorganic compound include: a method of changing the pH or composition of the solvent to decrease the solubility of the raw material of the second inorganic compound; and a method of changing the raw material of the second inorganic compound to a substance having low solubility in the solvent. The precursor of the second inorganic compound is precipitated in the solution obtained in the step (2), to thereby produce a mixture containing the particle group of the first inorganic compound and the precursor of the second inorganic compound. The precursor of the second inorganic compound is desirably precipitated on the surface of the particle of the first inorganic compound.

### Step

The method for separating the mixture containing the particle group of the first inorganic compound and the precursor of the second inorganic compound from the solvent is not particularly limited. Examples thereof include a method of separating the mixture by filtration using a filter paper or a membrane filter and a filtration device.

### Step

The method for converting the precursor of the second inorganic compound in the mixture from which the solvent has been separated, into the second inorganic compound is not particularly limited. Examples thereof include a method of placing the mixture from which the solvent has been separated in an electric furnace and heating the mixture. The precursor of the second inorganic compound is converted into the second inorganic compound, to thereby produce a particle group including coated particles, each of the coated particles including: a core part made of the first inorganic compound; and a shell part covering at least a part of the surface of the core part and made of the second inorganic compound.

### Step

When the particle group containing the first inorganic compound and the second inorganic compound forms massive products, the massive products may be crushed as necessary. The crushing method is not particularly limited, and examples thereof include a method of placing massive products in a mortar and crushing the massive products with a pestle; and a method of crushing massive products by using a ball mill. The average particle diameter of the resulting coated particles can be adjusted by appropriately changing the conditions of crushing, for example, the strength of the force to be applied and the time for crushing.

### Powder Composition Containing Coated Particles

An embodiment of the present invention is a powder composition containing the particle group of the coated particles and another powder. Such a powder composition can be suitably used as a filler for controlling the thermal expansion coefficient of a solid composition described later. The content of the coated particle in the powder composition is not limited, and a function of controlling the thermal expansion amount according to the content can be exhibited. From the viewpoint of efficiently controlling the thermal expansion amount, the content of the coated particle may be 75 mass% or more, 85% mass% or more, or 95 mass% or more.

Examples of another powder other than the particle group of coated particles in the powder composition are calcium carbonate, talc, mica, silica, clay, wollastonite, potassium titanate, xonotlite, gypsum fiber, aluminum borate, aramid fiber, carbon fiber, glass fiber, glass flake, polyoxybenzoyl whisker, glass balloon, carbon black, graphite, alumina, aluminum nitride, boron nitride, beryllium oxide, ferrite, iron oxide, barium titanate, lead zirconate titanate, zeolite, iron powder, aluminum powder, barium sulfate, zinc borate, red phosphorus, magnesium oxide, hydrotalcite, antimony oxide, aluminum hydroxide, magnesium hydroxide, zinc carbonate, TiO₂, and TiO.

The D50 of the powder composition can be set in the same manner as the D50 of the particle group of the coated particles described above.

The method for producing a powder composition is not particularly limited, but for example, the particle group of the coated particles and another powder are mixed, and then the particle diameter distribution may be adjusted by crushing, sieving, pulverizing or the like as necessary.

### Compact

The compact according to the present embodiment is a compact of the particle group of the coated particles or the powder composition. The compact in the present embodiment may be a sintered body obtained by sintering the particle group of the coated particles or the powder composition.

The compact is usually obtained by sintering the particle group of the coated particles or the powder composition. In this case, it is preferable to perform sintering in a temperature range in which the crystal structure of the first inorganic compound in the coated particles is maintained.

In order to obtain a sintered body, various known sintering methods can be applied. As a method for obtaining a sintered body, methods such as normal heating, hot pressing, and spark plasma sintering can be employed.

The compact according to the present embodiment is not limited to the sintered body, and may be, for example, a green compact obtained by compacting the particle group of the coated particles or the powder composition under pressure.

According to the compact of the particle group of the coated particles and the powder composition according to the present embodiment, it is possible to provide a member with reduced thermal expansion and thus extremely reduce the dimensional change of the member when the temperature varies. Therefore, the present invention can be suitably used for various members used in equipment particularly sensitive to a dimensional change due to temperature.

The molded article according to the present embodiment includes the particle group of the coated particles, and the coated particles have the core part made of the first inorganic compound satisfying the requirement 1. Therefore, the linear thermal expansion coefficient of the compact can be reduced as compared with the case where the coated particles are not added. Therefore, with the compact, it is possible to provide a member having an extremely small dimensional change when the temperature varies. The compact according to the present embodiment can be suitably used for an optical member or a semiconductor manufacturing equipment member which is particularly sensitive to a dimensional change due to temperature accordingly.

In addition, the coated particle has the shell part made of the second inorganic compound having a higher volume resistivity than that of the first inorganic compound, and thus can sufficiently increase the volume resistivity in the compact. It is therefore easy to adapt the compact to a member requiring electrical insulation properties.

### Solid Composition

The solid composition according to the present embodiment contains the particle group of the coated particles or the powder composition, and a first material.

### First Material

The first material is not particularly limited, and examples thereof include resins, alkali metal silicates, ceramics, and metals. The first material can be a binder material that bonds the coated particles, or a matrix material that holds the particle group of the coated particles or the powder composition in a dispersed state.

Examples of the resin include a thermoplastic resin and a cured product of a heat or active energy ray-curable resin.

Examples of the thermoplastic resin are polyolefin (polyethylene, polypropylene, etc.), ABS resin, polyamide (nylon 6, nylon 6,6, etc.), polyamide imide, polyester (polyethylene terephthalate, polyethylene naphthalate), a liquid crystal polymer, polyphenylene ether, polyacetal, polycarbonate, polyphenylene sulfide, polyimide, polyetherimide, polyether sulfone, polyketone, polystyrene, and polyetheretherketone.

Examples of the heat-curable resin (thermosetting resin) include epoxy resin, oxetane resin, unsaturated polyester resin, alkyd resin, phenol resin (novolac resin, resol resin, etc.), acrylic resin, urethane resin, silicone resin, polyimide resin, and melamine resin.

Examples of the active energy ray-curable resin are an ultraviolet ray-curable resin and an electron beam-curable resin, and can be, for example, urethane acrylate resin, epoxy acrylate resin, acrylic acrylate resin, polyester acrylate resin, or phenol methacrylate resin. Other examples of the resin include silicone-based, urethane-based, rubber-based, and acrylic pressure-sensitive adhesives.

The first material may contain one type of the resin or two or more types of the resins.

The first material is preferably epoxy resin, polyether sulfone, a liquid crystal polymer, polyimide, polyamide imide, or silicone from the viewpoint of being able to enhance heat resistance.

Examples of the alkali metal silicate include lithium silicate, sodium silicate, and potassium silicate. The first material may contain one type of alkali metal silicate or two or more types of alkali metal silicates. These materials are preferable because they have high heat resistance.

The ceramic is not particularly limited, and examples include ceramics such as alumina, silica (silicon oxide and silica glass), titania, zirconia, magnesia, ceria, yttria, oxide-based ceramics such as zinc oxide and iron oxide; nitride-based ceramics such as silicon nitride, titanium nitride, and boron nitride; silicon carbide, calcium carbonate, aluminum sulfate, barium sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomaceous earth, and silica sand. The first material may contain one type of ceramic or two or more types of ceramics.

Ceramics are preferable because they can increase heat resistance. A sintered body can be produced by spark plasma sintering or the like.

The metal is not particularly limited, and examples thereof include elementary metals such as aluminum, tantalum, niobium, titanium, molybdenum, iron, nickel, cobalt, chromium, copper, silver, gold, platinum, lead, tin, and tungsten, alloys such as stainless steel (SUS), and mixtures thereof. The first material may contain one type of metal or two or more types of metals. Such metals are preferable because they can increase heat resistance.

### Other Components

The solid composition may contain components other than the first material and the particle group of the coated particles or the powder composition. Examples of the other components include a catalyst. The catalyst is not particularly limited, and examples thereof include acidic compounds, alkaline compounds, and organometallic compounds. As the acidic compound, acids such as hydrochloric acid, sulfuric acid, nitric acid, phosphoric acid, phosphoric acid, formic acid, acetic acid, and oxalic acid can be used. As the alkaline compound, ammonium hydroxide, tetramethylammonium hydroxide, tetraethylammonium hydroxide, or the like can be used. Examples of the organometallic compound include those containing aluminum, zirconium, tin, titanium, and zinc.

The content of the coated particle in the solid composition is not particularly limited, and the solid composition can exhibit a function of controlling thermal expansion according to the content. The content of the coated particle in the solid composition can be, for example, 1 wt% or more, 3 wt% or more, 5 wt% or more, 10 wt% or more, 20 wt% or more, 40 wt% or more, or 70 wt% or more. When the content of the coated particle is increased, an effect of reducing the linear thermal expansion coefficient is easily exhibited. The content of the coated particle in the solid composition can be, for example, 99 wt% or less. The content of the coated particle in the solid composition may be 95 wt% or less, or 90 wt% or less.

The content of the first material in the solid composition can be, for example, 1 wt% or more. The content of the first material in the solid composition may be 5 wt% or more, or 10 wt% or more. The content of the first material in the solid composition can be, for example, 99 wt% or less. The content of the first material in the solid composition may be 97 wt% or less, 95 wt% or less, 90 wt% or less,80 wt% or less, 60 wt% or less, or 30 wt% or less.

The solid composition according to the present embodiment includes the particle group of the coated particles, and the coated particles have the core part made of the first inorganic compound satisfying the requirement 1. Therefore, the linear thermal expansion coefficient of the solid composition can be reduced as compared with the case where the coated particles are not added. Therefore, with the solid composition, it is possible to provide a member having an extremely small dimensional change when the temperature varies. The solid composition according to the present embodiment can be suitably used for an optical member or a semiconductor manufacturing equipment member which is particularly sensitive to a dimensional change due to temperature accordingly.

In addition, the coated particle has the shell part made of the second inorganic compound having a higher volume resistivity than that of the first inorganic compound, and thus can prevent reduction in the volume resistivity in the solid composition as compared with the case where the coated particle is not included in the solid composition.

### Liquid Composition

The liquid composition according to the present embodiment contains the particle group of the coated particles or the powder composition, and a second material. The liquid composition is a composition having fluidity at 25° C. This liquid composition can be a raw material of the solid composition described above.

The phrase “having fluidity at 25° C.” means that a liquid composition is supplied to a predetermined container and the liquid level of the composition is made horizontal, then the container is inclined by 45 degrees, and after 1 hour, the liquid level moves or deforms.

### Second Material

The second material is in a liquid state, and may be one in which the particle group of the coated particles or the powder composition can be dispersed. The second material can be a raw material of the first material.

For example, when the first material is an alkali metal silicate, the second material can contain an alkali metal silicate and a solvent capable of dissolving or dispersing the alkali metal silicate. When the first material is a thermoplastic resin, the second material can contain a thermoplastic resin and a solvent capable of dissolving or dispersing the thermoplastic resin. When the first material is a cured product of a heat or active energy ray-curable resin, the second material is a heat or active energy ray-curable resin before curing.

The heat-curable resin before curing has fluidity at room temperature, and is cured by a crosslinking reaction or the like when heated. The heat-curable resin before curing may contain one type of resin or two or more types of resins.

The active energy ray-curable resin before curing has fluidity at room temperature, and is cured by a crosslinking reaction or the like caused by irradiation with an active energy ray such as light (UV or the like) or an electron beam. The active energy ray-curable resin before curing contains a curable monomer and/or a curable oligomer, and can further contain a solvent and/or a photoinitiator as necessary. Examples of the curable monomer and curable oligomer are photocurable monomers and photocurable oligomers. Examples of the photocurable monomer are monofunctional or polyfunctional acrylate monomers. Examples of the photocurable oligomer are urethane acrylate, epoxy acrylate, acrylic acrylate, polyester acrylate, and phenol methacrylate.

Examples of the solvent include organic solvents such as an alcohol solvent, an ether solvent, a ketone solvent, a glycol solvent, a hydrocarbon solvent, or an aprotic polar solvent; and water. The solvent in the case of an alkali metal silicate is, for example, water.

### Other components

The liquid composition of the present embodiment may contain components other than the second material and the particle group of the coated particles or the powder composition. The liquid composition of the present embodiment can contain, for example, other components listed in the first material.

The content of the coated particle in the liquid composition is not particularly limited, and can be appropriately set from the viewpoint of controlling the thermal expansion coefficient in the solid composition after curing. Specifically, the content of the coated particle in the liquid composition can be the same as the content of the coated particle in the solid composition.

### Method for Producing Liquid Composition

The method for producing a liquid composition is not particularly limited. The liquid composition can be obtained by, for example, stirring and mixing the particle group of the coated particles or the powder composition with the second material. Examples of the stirring method include stirring and mixing with a mixer. Alternatively, it is possible to disperse the coated particles in the second material by ultrasonic treatment.

Examples of the mixing method used in the mixing step include a ball mill method, a rotation/revolution mixer, an impeller spinning method, a blade spinning method, a thin-film spinning method, a rotor/stator type mixer method, a colloid mill method, a high-pressure homogenizer method, and an ultrasonic dispersion method. In the mixing step, a plurality of mixing methods may be performed in order, or a plurality of mixing methods may be performed simultaneously.

Homogenizing and shearing the composition in the mixing step can enhance the fluidity and deformability of the composition.

### Method for Producing Solid Composition

After the liquid composition is formed into a desired shape, the second material in the liquid composition is converted into the first material, whereby a solid composition, in which the particle group of the coated particles and the first material are composited, can be produced.

For example, in a case where the second material contains an alkali metal silicate and a solvent capable of dissolving or dispersing the alkali metal silicate, and in a case where the second material contains a thermoplastic resin and a solvent capable of dissolving or dispersing the thermoplastic resin, a solid composition containing the particle group of the coated particles and the first material (alkali metal salt or thermoplastic resin) can be obtained by forming the liquid composition into a desired shape and removing the solvent from the liquid composition.

As a method of removing the solvent, a method of evaporating the solvent by natural drying, vacuum drying, heating, or the like can be applied. From the viewpoint of suppressing generation of coarse bubbles, when removing the solvent, it is preferable to remove the solvent while maintaining the temperature of the mixture at a temperature equal to or lower than the boiling point of the solvent.

When the second material is a heat or active energy ray-curable resin before curing, the liquid composition may be cured by heat or an active energy ray (UV or the like) after forming the liquid composition into a desired shape.

Examples of a method for forming the liquid composition into a predetermined shape include pouring the liquid composition into a mold; and applying the liquid composition onto the surface of a substrate to form a film shape.

In addition, when the first material is a ceramic or a metal, the following can be performed. A mixture of raw material powder of the first material and the particle group of the coated particles or powder mixture is prepared, and the mixture is heat-treated to sinter the raw material powder of the first material, thereby producing a solid composition containing the first material as a sintered body and the particle group of the coated particles or powder mixture. The pores of the solid composition can be adjusted as necessary by a heat treatment such as annealing. As the sintering method, methods such as normal heating, hot pressing, and spark plasma sintering can be employed.

In the spark plasma sintering, a pulsed current is applied to the mixture of the raw material powder of the first material and the particle group of the coated particles or powder mixture while the mixture is pressurized. As a result, electric discharge occurs between the raw material powders of the first material, so that the raw material powder of the first material can be heated and sintered.

The plasma sintering step is preferably performed under an inert atmosphere such as argon, nitrogen, or vacuum in order to prevent the resulting compound from being deteriorated by contact with air.

The pressure applied in the plasma sintering step is preferably in a range of more than 0 MPa and 100 MPa or less. In order to obtain a high-density first material, the pressure applied in the plasma sintering step is preferably 10 MPa or more, and more preferably 30 MPa or more.

The heating temperature in the plasma sintering step is preferably sufficiently lower than the melting point of the first material as an object.

Furthermore, the size and distribution of pores can be adjusted by a heat treatment of the resulting solid composition.

Subsequently, specific use forms of the solid composition and the compact will be described.

The solid composition and the compact according to the embodiment are excellent in electrical insulation properties, and thus can be a member for electronic devices, a mechanical member, a container, an optical member, or an adhesive.

### Member for Electronic Devices

Examples of the member for electronic devices include a sealing member, a conductive adhesive, a circuit board, a prepreg, and an insulating sheet.

Examples of the sealing member include a sealing member of a semiconductor element, an underfill member, and an interchip fill for a 3D-LSI. Examples of the semiconductor element include a power semiconductor such as a power transistor and a power IC; and a light emitting element such as an LED element. According to the sealing member produced by using the solid composition and the compact, it is possible to suppress cracking due to a difference in linear thermal expansion coefficient.

Examples of the conductive adhesive include an anisotropic conductive film and an anisotropic conductive paste. Inclusion of the coated particle of the present embodiment in the conductive adhesive can reduce the linear thermal expansion of the adhesive member, and thus can eliminate problems such as cracking and warpage in the contact portion between different types of materials, and also improve electrical insulation properties.

The circuit board includes a metal layer and an electrically insulating layer provided on the metal layer. Use of the solid composition and the compact for the electrically insulating layer can reduce the linear thermal expansion coefficient while maintaining electrical insulation properties to thereby reduce the difference in the linear thermal expansion coefficient between the metal layer, and thus can eliminate problems such as warpage and cracking. Specific examples of the circuit board include a printed circuit board, a multilayer printed wiring board, a build-up board, and a capacitor built-in board.

The prepreg is a semi-cured product of an impregnated material containing a reinforcing material and a matrix material impregnated into the reinforcing material. Inclusion of the coated particles of the present embodiment in the prepreg allows the prepreg after curing to exhibit high dimensional stability even in an environment where a thermal load is applied.

An example of the insulating sheet is a resin sheet such as a sheet made of polyvinyl chloride. Inclusion of the coated particles in the insulating sheet makes it possible to improve dimensional accuracy while maintaining electrical insulation properties.

### Mechanical Member

The mechanical member is a member constituting various types of mechanical equipment. Examples of the mechanical equipment include machine tools such as cutting equipment, processing devices, and semiconductor manufacturing equipment. Examples of the mechanical member include a fixing mechanism, a moving mechanism, and a tool. According to the heat dissipation member produced by using the solid composition and the compact, dimensional deviation due to thermal expansion can be suppressed, and accuracy such as machining accuracy and processing accuracy can be improved. In addition, the solid composition and the compact are suitable for use in a joint portion between members made of different materials.

The mechanical member may be a rotating member. The rotating member refers to a member that exerts a mechanical action on another member while rotating, such as a gear. When the dimension of the rotating member changes due to thermal expansion, problems such as poor engaging and abrasion occur. Thus, the solid composition and the compact are suitable for application to the rotating member.

The mechanical member may be a substrate. When the dimension of the substrate changes due to thermal expansion, a problem such as misalignment occurs. Thus, the solid composition and the compact are suitable for application to the substrate.

### Container

The container is a member for accommodating gas, liquid, solid, or the like. For example, an example of the container is a mold for producing a compact. For example, when the dimension of the mold changes due to thermal expansion, a problem occurs that the dimensional accuracy of the compact cannot be maintained. Thus, the solid composition and the compact are suitable for application to the mold.

### Optical Member

Examples of the optical member include an optical fiber, an optical waveguide, a lens, a reflecting mirror, a prism, an optical filter, a diffraction grating, a fiber grating, and a wavelength conversion member. Examples of the lens include an optical pickup lens and a camera lens. Examples of the optical waveguide include an array waveguide and a planar optical circuit.

The optical member has a problem that the characteristics thereof vary when the lattice spacing, the refractive index, the optical path length, or the like changes with a change in temperature. According to the optical member, or the fixing member or supporting substrate of the optical member produced by using the solid composition and the compact, it is possible to reduce such variation in characteristics of the optical member depending on the temperature.

### Adhesive

Examples of the adhesive include an adhesive containing a thermosetting resin such as epoxy or silicone resin as a matrix material and the coated particles. The adhesive may be in a liquid state or a solid state before curing. Since the cured product of the adhesive can have a low linear thermal expansion coefficient, cracking can be suppressed. In particular, the adhesive is suitable for application to a heat-resistant adhesive member to which a thermal load is applied.

### EXAMPLES

Hereinafter, the present invention will be described in more detail with reference to Examples.

### 1. Crystal Structure Analysis of First Inorganic Compound of Coated Particle

As the analysis of the crystal structure, a particle group of coated particles was subjected to powder X-ray diffractometry at different temperatures under the following conditions using a powder X-ray diffraction measuring apparatus SmartLab (manufactured by Rigaku Corporation) to obtain a powder X-ray diffraction pattern. For the first inorganic compound, the lattice constant was refined based on the obtained powder X-ray diffraction pattern by the least-squares method using PDXL2 software (manufactured by Rigaku Corporation), and two lattice constants, that is, the a-axis length and the c-axis length were obtained.

Measuring apparatus: powder X-ray diffraction measuring apparatus SmartLab (manufactured by Rigaku Corporation)
X-ray generator: CuKα source, voltage 45 kV, current 200 mA
Slit: slit width 2 mm
Scan step: 0.02 deg
Scan range: 5 to 80 deg
Scan speed: 10 deg/min
X-ray detector: one-dimensional semiconductor detector
Measurement atmosphere: Ar 100 mL/min
Sample stage: dedicated glass substrate made of SiO₂

### 2. X-ray Photoelectron Spectroscopy (XPS) of Surface of Coated Particle

XPS (using Quantera SXM, manufactured by ULVAC-PHI, Incorporated.) was performed on the surface of coated particles produced by the method described later. Specifically, the obtained coated particles were filled in a dedicated substrate, and using an Al-Kα ray as the X-ray source, measurement was performed by charge neutralization with electrons and Ar ions, with the photoelectron extraction angle set to 45 degrees and the aperture diameter set to 100 µm, and thus a spectrum was acquired. Then, using XPS data analysis software “MuitiPak” (manufactured by ULVAC-PHI, Incorporated), charge correction was performed with the peak attributed to adventitious hydrocarbons being 284.6 eV in the 1s spectrum of carbon. Thereafter, peak fitting was performed on the peak detected in a region of the 2p spectrum of titanium and the peak detected in a region of the 2s spectrum of aluminum or silicon. The area values of the peaks were obtained through peak fitting, and each of the area values was multiplied by a relative sensitivity factor of the apparatus to calculate the ratio of the number of atoms Q_{XPS}, _{SHELL} of the metal or semimetal element Q to the number of atoms P_{XPS}, _{CORE} of the metal or semimetal element P, that is, the ratio M (Q_{XPS}, _{SHELL}/P_{XPS}, _{CORE}) of the number of atoms.

### 3. Calculation of Ratio of Number of Atoms of Metal or Semimetal Element Q to Number of Atoms of Metal or Semimetal Element P Contained in Entire Coated Particle

An amount of 20 mg of a particle group of coated particles produced by the method described later was weighed and placed in a nickel crucible. When the metal or semimetal element Q was Al, 3 g of sodium hydroxide (manufactured by Merck KGaA, for (granular) analysis) was added as a flux, and when the metal or semimetal element Q was Si, 3 g of sodium hydroxide (FUJIFILM Wako Pure Chemical Corporation, guaranteed reagent) was added as a flux to the particles. Thereafter, the nickel crucible was placed in an electric furnace, followed by heating at 600° C. for 20 minutes to perform alkali fusion. To the resulting melt, 30 mL of pure water was added to dissolve the melt. Then, the solution was transferred to a PTFE beaker, and 20 mL of hydrochloric acid (manufactured by FUJIFILM Wako Pure Chemical Corporation, for precision analysis, concentration: 35 to 37%) diluted two times with pure water was added to make the solution acidic. Thereafter, the acidic solution was placed on a hot plate and heated for 1 hour so as to be 80° C., and it was visually confirmed that there was no residue. Pure water was added to the solution in which the coated particles have been completely dissolved to make 100 mL of solution, and the solution was diluted 10 times. This sample solution was introduced into an inductively coupled plasma atomic emission spectroscopy (ICP-AES) (SPS3000, manufactured by SII NanoTechnology Inc.) apparatus, and quantitative analysis for the metal or semimetal element P and the metal or semimetal element Q contained in the sample solution was performed. Incidentally, a standard solution for atomic absorption of the metal or semimetal element P and the metal or semimetal element Q (in the case of Ti: FUJIFILM Wako Pure Chemical Corporation, titanium standard solution (Ti 1000), in the case of Al: FUJIFILM Wako Pure Chemical Corporation, aluminum standard solution (Al 100), in the case of Si: FUJIFILM Wako Pure Chemical Corporation, silicon standard solution (Si 1000)) was added to a blank solution to which only an alkali and an acid were added so as to have the same concentration as the sample solution to prepare a standard solution. This standard solution was used to quantify the metal or semimetal element P and the metal or semimetal element Q by a calibration curve method. From the obtained results of ICP-AES, the ratio N (Q_{ALL}/P_{ALL}) of the number of atoms Q_{ALL} of the metal or semimetal element Q to the number of atoms P_{ALL} of the metal or semimetal element P contained in the entire coated particle was calculated.

### 4. Evaluation of Volume Resistivity of Coated Particle

As the evaluation of the volume resistivity of the coated particle, measurement was performed using a powder resistance measurement unit MCP-PD51 (manufactured by Mitsubishi Chemical Analytech Co., Ltd.), a low resistivity meter Loresta-GP MCP-T610 (manufactured by Mitsubishi Chemical Analytech Co., Ltd.), and a manual hydraulic pump (manufactured by Enerpac Co., Ltd.). An amount of 1.5 g of a particle group of coated particles was placed in a cylinder with a radius of 10.0 mm of the resistance measurement unit. Then, a pressure of 64 MPa was applied to the particle group of the coated particles with the manual hydraulic pump, and the resistance value was measured with the low resistivity meter. The volume resistivity of the coated particle was calculated from the resistance value of the particle group of the coated particles, the distance between terminals, and the cylinder diameter at the measurement.

A case where the volume resistivity of the coated particle was 10³ Ωcm or more was evaluated as good electrical insulation properties.

### 5. Evaluation of Thermal Expansion Control Characteristics (Sodium Silicate Composite Material)

Thermal expansion control characteristics were evaluated by the following method.

A mixture was obtained by mixing 80 parts by weight of a particle group of coated particles, 20 parts by weight of No. 1 sodium silicate (manufactured by Fuji Chemical Co., Ltd.), and 10 parts by weight of pure water. The resulting mixture was placed in a mold made of polytetrafluoroethylene and cured by the following curing profile. The temperature was raised to 80° C. in 15 minutes, held at 80° C. for 20 minutes, then raised to 150° C. in 20 minutes, and held at 150° C. for 60 minutes. Thereafter, a treatment of raising the temperature to 320° C., holding the temperature for 10 minutes, and lowering the temperature was performed to obtain a solid composition through the above steps.

The linear thermal expansion coefficient of the obtained solid composition was measured using the following apparatus.

Measuring apparatus: Thermo plus EVO2, TMA series, Thermo plus 8310

The measurement conditions were as follows: temperature range: 25° C. to 320° C., temperature change rate: 10° C./min, and sampling interval: 2.7 seconds. As a representative value, the value of the linear thermal expansion coefficient at 190 to 210° C. was calculated.

Reference solid: alumina

The typical size of the measurement sample of the solid composition was 15 mm × 4 mm × 4 mm.

The longest side of the measurement sample of the solid composition was set as the sample length L, and the sample length L (T) at the temperature T was measured. The dimensional change rate ΔL(T)/L(30° C.) with respect to the sample length at 30° C. (L(30° C.)) was calculated by the following equation.

$$Δ \text{L} \left(\text{T}\right) / \text{L} \left(30 ° \text{C}\right) = \left(\text{L} \left(\text{T}\right) - \text{L} \left(30 ° \text{C}\right)\right) / \text{L} \left(30 ° \text{C}\right)$$

The dimensional change rate ΔL(T)/L (30° C.) was determined in a temperature range of 190° C. to 210° C. Then, a slope obtained by performing linear approximation of the dimensional change rate ΔL(T)/L (30° C.), as a function of T, by a least-squares method was defined as a linear thermal expansion coefficient α (⅟°C) at 190° C. to 210° C.

A case where the value of the linear thermal expansion coefficient was -10 ppm/°C or less was evaluated as good thermal expansion control characteristics.

### 6. Measurement of Particle Diameter Distribution Of Particle Group of Coated Particles

The particle diameter distribution of the particle group of the coated particles was measured by the following method.

Pretreatment: 99 parts by weight of water was added to 1 part by weight of a particle group of coated particles for dilution, and ultrasonic treatment was performed with an ultrasonic cleaner. The ultrasonic treatment time was set to 10 minutes, and NS200-6U, manufactured by NISSEI Corporation was used as the ultrasonic cleaner. The frequency of the ultrasonic wave was about 28 kHz.

Measurement: The volume-based particle diameter distribution was measured by a laser diffraction scattering method.

Measurement conditions: The refractive index of Ti₂O₃ particles was set to 2.40.

Measuring apparatus: Laser diffraction particle diameter distribution measuring apparatus, Mastersizer 2000 (Malvern Instruments Ltd.)

### Examples 1 to 6 and Comparative Examples 1 to 6

Core particles 1 and 2 of Examples 1 to 6 and Comparative Examples 2 to 6 were obtained by the following method.

### Core Particles 1 and 2

In a 1 L plastic polyethylene bottle (outer diameter: 97.4 mm), 1,000 g of 2 mmφ zirconia balls, 166.7 g of TiO₂ (CR-EL, manufactured by Ishihara Sangyo Kaisha, Ltd.), and 33.3 g of Ti (less than 38 µm, manufactured by Kojundo Chemical Lab. Co., Ltd.) were placed, and the 1 L polyethylene bottle was placed on a ball mill stand. Mixing was performed using a ball mill at a rotation speed of 60 rpm for 4 hours to prepare 200 g of raw material mixed powder. The above operation was repeated five times to prepare 1,000 g of raw material mixed powder.

The raw material mixed powder (1,000 g) was filled in a firing container (manufactured by NIKKATO Corporation, SSA-T, 150 mm square crucible), and the container was placed in an electric furnace (FD-40 × 40 × 60-1Z4-18TMP, manufactured by NEMS Co., Ltd.). Then, the atmosphere in the electric furnace was purged with Ar, and the raw material mixed powder was fired. The firing program was set such that the temperature was raised from 0° C. to 1,500° C. in 15 hours, held at 1,500° C. for 3 hours, and lowered from 1,500° C. to 0° C. in 15 hours. Ar gas was allowed to flow at a flow rate of 2 L/min during the firing program operation. After firing, powder 1 was obtained. The powder 1 was classified using a sieve with a mesh size of 45 µm and a sieve with a mesh size of 180 µm so as to have a particle diameter of 45 µm or more and 180 µm or less, thereby obtaining powder 2. The powder 2 was pulverized for 10 minutes with a mortar and a pestle to obtain core particles 1. The powder 1 was classified using a sieve with a mesh size of 20 µm so as to have a particle diameter of 20 µm or less, thereby obtaining powder 3. The powder 3 was immersed in an aqueous solution (1.0 mol/L) of sodium hydroxide (manufactured by FUJIFILM Wako Pure Chemical Corporation) for 24 hours, then filtrated, and washed with pure water to obtain core particles 2. The metal element contained in the core particles 1 and 2 was only Ti.

### Examples 1 to 5

Sodium aluminate (manufactured by FUJIFILM Wako Pure Chemical Corporation) in the amount shown in Table 1 was mixed with 40 mL of pure water to prepare a solution, and sulfuric acid (1.0 mol/L, manufactured by FUJIFILM Wako Pure Chemical Corporation) was added dropwise to the solution while stirring to adjust the pH of the solution to the value shown in Table 1, thereby preparing a basic aluminum ion aqueous solution. Then, 2,300 g of the core particles 1 were mixed with 10 mL of pure water to prepare a dispersion of the core particles 1. The dispersion was mixed with the basic aluminum ion aqueous solution, and stirred at 300 rpm for 10 minutes to prepare a mixed liquid. Sulfuric acid (1.0 mol/L, manufactured by FUJIFILM Wako Pure Chemical Corporation) was added dropwise to the mixed liquid while stirring to adjust the pH of the mixed liquid to 8.0, thereby obtaining a pH-adjusted mixed liquid. The pH-adjusted mixed liquid was subjected to suction filtration using filter paper (No. 1, 90 mmφ, manufactured by Advantech Co., Ltd.) to obtain a residue. The residue was mixed with 200 mL of pure water, stirred for 10 minutes, and again subjected to suction filtration under the same conditions to obtain a washed residue. The washed residue was placed on a drying dish and placed in a drying furnace, and the washed residue was dried. The temperature raising program was set such that the temperature was raised from 20° C. to 80° C. in 15 minutes, held at 80° C. for 20 minutes, raised from 80° C. to 150° C. in 30 minutes, held at 150° C. for 10 hours, and lowered from 150° C. to 20° C. by natural cooling. After drying, a massive solid was obtained.

In Examples 1, 3, and 5, the massive solid was crushed with a mortar and a pestle, and further pulverized for 10 minutes with the mortar and the pestle to obtain a particle group of coated particles.

In Examples 2 and 4, the massive solid was crushed with a mortar and a pestle, and a particle group of coated particles was obtained without pulverization.

### Comparative Example 1

The core particles 1 were used as particles of Comparative Example 1.

### Comparative Examples 2 to 6

Particle groups of coated particles of Comparative Examples 2 to 6 were obtained by the same method as in Examples 1 to 5 except that the amount of sodium aluminate, the pH of the basic aluminum ion aqueous solution, and the presence or absence of pulverization were changed.

### Example 6

Pure water (15 mL) and 6 mL of aqueous ammonia (manufactured by FUJIFILM Wako Pure Chemical Corporation) were mixed with 115 mL of ethanol (manufactured by FUJIFILM Wako Pure Chemical Corporation) to prepare a solution, and 15 g of the core particles 2 were mixed while stirring the solution to prepare a dispersion of the core particles 2. Then, 24 mL of tetraethyl orthosilicate (manufactured by FUJIFILM Wako Pure Chemical Corporation) was mixed with the dispersion while being stirred, and mixing was continued at room temperature for 6 hours to prepare a mixed liquid. The mixed liquid was subjected to suction filtration using filter paper (No. 1, 90 mmφ, manufactured by Advantech Co., Ltd.) to obtain a residue. The residue was mixed with 100 mL of pure water, stirred for 10 minutes, and again subjected to suction filtration under the same conditions to obtain a washed residue. The washed residue was placed on a drying dish and placed in a drying furnace, and the washed residue was dried. The temperature raising program was set such that the temperature was raised from 20° C. to 80° C. in 15 minutes, held at 80° C. for 20 minutes, raised from 80° C. to 150° C. in 30 minutes, held at 150° C. for 10 hours, and lowered from 150° C. to 20° C. by natural cooling. After drying, a particle group of coated particles was obtained.

From the results of powder X-ray diffractometry, the core part made of the first inorganic compound of the coated particles obtained in Examples 1 to 6 was corundum type titanium oxide. Using the obtained a-axis length and c-axis length, |dA (T)/dT| of titanium oxides of Examples 1 to 6 at T1 of 150° C. was obtained by the following Equation (D) .

$$\left|\text{dA} \left(\text{T}\right) / \text{dT}\right| = \left|\text{A} \left(\text{T + 50}\right) - \text{A} \left(\text{T}\right)\right| / 50$$

The results of ICP-AES showed that the coated particles obtained in Examples 1 to 5 were a compound composed of titanium and aluminum. The results showed that the second inorganic compound of the coated particles obtained in Examples 1 to 5 were a compound composed of aluminum, and the second inorganic compound contained at least one compound selected from the group consisting of aluminum oxide, aluminum hydroxide oxide, and aluminum hydroxide.

In Examples 1 to 5 and Comparative Examples 2 to 6, the metal or semimetal element contained in the core part made of the first inorganic compound was only Ti, and the metal or semimetal element contained in the shell part made of the second inorganic compound was only Al. Therefore, the metal or semimetal element P was Ti, and the metal or semimetal element Q was Al, which corresponded to the existence situation 1. From the results of XPS of the surface of the coated particle, the ratio M (Q(Al)_{XPS}, _{SHELL}/P(Ti)_{XPS}, _{CORE}) of the number of atoms Q(Al)_{XPS}, _{SHELL} of Al contained in the shell part to the number of atoms P(Ti)_{XPS}, _{CORE} of Ti contained in the core part was obtained.

The results of ICP-AES showed that the coated particle obtained in Example 6 was a compound composed of titanium and silicon. This result revealed that the second inorganic compound of the coated particle obtained in Example 6 was a compound composed of silicon, and the second inorganic compound contained silicon oxide.

In Example 6, the metal or semimetal element contained in the core part made of the first inorganic compound was only Ti, and the metal or semimetal element contained in the shell part made of the second inorganic compound was only Si. Therefore, the metal or semimetal element P was Ti, and the metal or semimetal element Q was Si, which corresponded to the existence situation 1. From the results of XPS of the surface of the coated particle, the ratio M (Q(Si)_{XPS}, _{SHELL}/P(Ti)_{XPS}, _{CORE}) of the number of atoms Q(Si)_{XPS}, _{SHELL} of Si contained in the shell part to the number of atoms P(Ti)_{XPS}, _{CORE} of Ti contained in the core part was obtained.

From the results of ICP-AES, the ratio N (Q(Al)_{ALL}/P(Ti)_{ALL}) of the number of Al atoms Q(Al)_{ALL} to the number of Ti atoms P(Ti)_{ALL} in each of the entire coated particles in Examples 1 to 5 was determined.

From the results of ICP-AES, the ratio N (Q(Si)_{ALL}/P(Ti)_{ALL}) of the number of Si atoms Q(Si)_{ALL} to the number of Ti atoms P(Ti)_{ALL} in the entire coated particle in Example 6 was determined.

The value of the ratio M and the value of the ratio N were compared, and the value of the ratio M was sufficiently larger than the value of the ratio N. It was therefore confirmed that the core part made of the first inorganic compound of the coated particle was covered with the shell part made of the second inorganic compound.

The obtained measurement results of Examples 1 to 6 and Comparative Examples 1 to 6 are summarized in Table 1.

TABLE 1

| | Sodium aluminate | pH of solution | Presence of pulverization | \|dA (T)/dT\| (T = 150° C.) | M | N | D50 | Linear thermal expansion coefficient @ 200° C. | Volume resistivity |
|---|---|---|---|---|---|---|---|---|---|
| | (g) | (-) | - | (ppm/°C) | (-) | (-) | (µm) | (ppm/°C) | (Ω cm) |
| Example 1 | 0.64 | 12.6 | Yes | 26 | 97 | 0.20 | 10.9 | -22 | 1 × 10⁷ |
| Example 2 | 0.99 | 12.8 | No | 42 | 81 | 0.33 | 21.0 | -16 | 8 × 10⁴ |
| Example 3 | 0.99 | 12.8 | Yes | 25 | 104 | 0.30 | 11.8 | -20 | > 10 ° |
| Example 4 | 1.49 | 13.0 | No | 45 | 261 | 0.50 | 17.1 | -19 | 3 ×10⁷ |
| Example 5 | 1.49 | 13.0 | Yes | 35 | 276 | 0.47 | 14.1 | -17 | > 10⁶ |
| Example 6 | – | – | – | 34 | 208 | 0.45 | 20.7 | -18 | > 10⁶ |
| Comparative Example 1 | – | – | – | – | – | – | 12.9 | -32 | 3 × 10⁻¹ |
| Comparative Example 2 | 0.37 | 12.4 | No | – | 24 | – | 14.6 | -26 | 1 × 10¹ |
| Comparative Example 3 | 0.37 | 12.4 | Yes | – | 40 | – | 11.2 | -20 | 3 × 10¹ |
| Comparative Example 4 | 0.64 | 12.6 | No | – | 26 | – | 20.7 | -17 | 2 x 10² |
| Comparative Example 5 | 6.17 | | No | – | 426 | – | 16.3 | -5 | > 108 |
| Comparative Example 6 | 6.17 | 15.6 | Yes | – | 305 | – | 9.9 | -7 | > 10⁸ |

According to the coated particles of Examples, the linear thermal expansion coefficient in the solid composition could be reduced, and the volume resistivity could be increased. That is, the particle group had excellent thermal expansion control characteristics and excellent electrical insulation properties.

### Description of Reference Signs

1 Core part
2 Shell part
10 Coated particle

1. A particle group comprising a plurality of coated particles, each of the coated particles including:
a core part made of a first inorganic compound containing a metal or semimetal element P; and
a shell part made of a second inorganic compound containing a metal or semimetal element Q, the shell part covering at least a part of a surface of the core part, wherein
the metal or semimetal element P and the metal or semimetal element Q are different elements from each other, or are the same elements but have different electronic states from each other,
a volume resistivity of the second inorganic compound is higher than a volume resistivity of the first inorganic compound,
the first inorganic compound satisfies requirement 1, and
each of the coated particles satisfies requirements 2 and 3:
requirement 1: |dA (T)/dT| is 10 ppm/°C or more at at least one temperature T1 in a range of -200° C. to 1,200° C.,
A is (an a-axis (shorter axis) lattice constant of a crystal in the first inorganic compound)/(a c-axis (longer axis) lattice constant of a crystal in the first inorganic compound), and
each of the lattice constants is obtained from X-ray diffractometry of the first inorganic compound;
requirement 2: in X-ray photoelectron spectroscopy (XPS) of a surface of each of the coated particles, a ratio Q_{XPS,} _{SHELL}/P_{XPS,} _{CORE} of a number of atoms Q_{XPS,} _{SHELL} of the metal or semimetal element Q contained in the shell part to a number of atoms P_{XPS,} _{CORE} of the metal or semimetal element P contained in the core part is 45 or more and 300 or less; and
requirement 3: an average particle diameter of each of the coated particles is 0.1 µm or more and 100 µm or less.

2. The particle group according to claim 1, wherein each of the coated particles further satisfies requirement 4:
requirement 4: in all of the coated particles included in the particle group, a ratio Q_{ALL}/P_{ALL} of a total Q_{ALL} of a number of atoms of the metal or semimetal element Q to a total P_{ALL} of a number of atoms of the metal or semimetal element P is 0.20 or more and 0.50 or less.

3. The particle group according to claim 1,wherein the metal or semimetal element P is a metal element having a d electron.

4. The particle group according to claim 1, wherein the metal or semimetal element P is titanium.

5. The particle group according to claim 1, wherein the first inorganic compound is TiOₓ where x is 1.30 to 1.66.

6. The particle group according to claim 1, wherein the metal or semimetal element Q is Al, Si, or Zr.

7. The particle group according to claim 1, wherein the second inorganic compound is at least one compound selected from the group consisting of an oxide, a hydroxide oxide, and a hydroxide.

8. The particle group according to claim 1, wherein the second inorganic compound is at least one compound selected from the group consisting of aluminum oxide, aluminum hydroxide oxide, and aluminum hydroxide.

9. A powder composition comprising the particle group according to claim 1.

10. A solid composition comprising the particle group according to claim 1.

11. A liquid composition comprising the particle group according to claim 1.

12. A compact of the particle group according to claim 1 .
